(19) United States
(12) Patent Application Publication
(10) Pub. No.: US 2016/0088078 A1
(43) Pub. Date: Mar. 24, 2016

(54) Instant Photo Sharing Arrangement and Method

(71) Applicant: Ningbo Sunny Opotach Co.,Ltd., Ningbo (CN)

(72) Inventors: Zhongwei WANG, Ningbo (CN); Shixin XU, Ningbo (CN); Wenjie WANG, Ningbo (CN)

(21) Appl. No.: 14/490,665

(22) Filed: Sep. 18, 2014

(51) Int. Cl. H04L 29/08; H04N 5/44; H04L 29/06; H04L 12/58; H04W 4/02

(52) U.S. Cl. CPC H04L 67/1095; H04L 51/32; H04W 4/021; H04L 65/403; H04N 5/44

(57) ABSTRACT

An instant photo sharing method includes the steps of capturing a photo by a digital device, and instantly sharing the photo over a communication network at the same time when the photo is captured by the digital device. Therefore, a user of the digital device is able to capture and instantly share the photo at the same time to a designated social network and/or other digital devices, so as to simplify the photo sharing procedure.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a photo sharing between digital devices over a network, and more particular to an instant photo sharing arrangement, wherein a user is able to instantly share a photo to others over a communication network at the same when the photo is captured.

2. Description of Related Arts

Social networks are widely used to share information, such as photos or videos, among friends. In particular, web-enabled mobile phones have become enormously popular, wherein an application of the social network is initially installed into the mobile phone, such that users of the mobile phone can directly link to the social network to upload information for sharing. However, there are several drawbacks for this method.

Firstly, the user must open a photo capturing application in the mobile phone to capture a photo by the mobile phone and save the photo in the photo album in the mobile phone. Then, the application of the social network is opened, such that the user can select the desired photo in the photo album and press or touch the upload button in order to upload the desired photo to the social network. It is a hassle for the user to upload one photo at a time through these steps. In other words, if the user wants to share the same photo to different social networks, the user must open different applications of the social networks and upload the same photo thereto.

In addition, some users want to edit the photo before it is uploaded. Therefore, a third party editing software must be installed into the mobile photo. In other words, after the photo is captured, the user is able to edit the photo and save edited photo in the photo album again in order to share the edited photo over the social network.

Accordingly, after the photo is shared over the social network, the user must enter the information of the photo, such as location and time, as a description of the photo. As a result, it is time consuming to share one photo over the network.

### SUMMARY OF THE PRESENT INVENTION

The invention is advantageous in that it provides an instant photo sharing method and arrangement, wherein a user is able to instantly share a photo to others over a communication network at the same when the photo is captured. Therefore, a user of the digital device is able to capture and instantly share the photo at the same time to a designated social network and/or other digital devices, so as to simplify the photo sharing procedure.

Another advantage of the invention is to provide an instant photo sharing method and arrangement, which is configured as a photo capturing and sharing software to be installed into any existing digital device such as mobile phone, computer, tablet, or digital camera.

Another advantage of the invention is to provide an instant photo sharing method and arrangement, wherein the user of the digital device is able to selectively share the photo to one or more sharing designations, including social network and/or other digital devices, at the same time when the photo is captured.

Another advantage of the invention is to provide an instant photo sharing method and arrangement, wherein information of the photo, including location, time and capturing orientation, is instantly and automatically shared over the communication network at the same time when the photo is shared.

Another advantage of the invention is to provide an instant photo sharing method and arrangement, wherein the photo can be edited before the photo is saved and instantly shared.

Another advantage of the invention is to provide an instant photo sharing method and arrangement, which does not require to alter the original design of the digital device, so as to minimize the cost of the instant photo sharing arrangement incorporating with the digital device.

Another advantage of the invention is to provide an instant photo sharing method and arrangement, wherein no expensive or complicated structure is required to employ in the present invention in order to achieve the above mentioned objects. Therefore, the present invention successfully provides an economic and efficient solution for instantly sharing the photo to others over the communication network at the same when the photo is captured.

Additional advantages and features of the invention will become apparent from the description which follows, and may be realized by means of the instrumentalities and combinations particular point out in the appended claims.

According to the present invention, the foregoing and other objects and advantages are attained by an instant photo sharing method includes the following steps.

(A) Capture a photo by a digital device.

(B) Instantly share the photo over a communication network at the same time when the photo is captured by the digital device. Therefore, a user of the digital device is able to capture and instantly share the photo at the same time to a designated social network and/or other digital devices, so as to simplify the photo sharing procedure.

In accordance with another aspect of the invention, the present invention comprises an instant photo sharing arrangement for a camera module, wherein the instant photo sharing arrangement comprises a user preference database and a photo sharing module.

The user preference database contains one or more sharing designations pre-configured by a user of the camera module, wherein the sharing designation can be a social network and/or other digital devices where the user wants to share the photo thereto.

The photo sharing module, which is linked to the user preference database, comprises a shutter button for operating the camera module to capture a photo, wherein when the photo is taken by the camera module via an actuation of the shutter button, the photo is captured and instantly shared at the same time to the sharing designation over a communication network.

In accordance with another aspect of the invention, the present invention comprises an instant photo sharing method includes the following steps.

(A) Capture and edit a photo by a digital device.

(B) Save the photo in the digital device.

(C) Instantly share the photo over a communication network at the same time when the photo is saved in the digital device. Therefore, a user of the digital device is able to capture, edit, and instantly share the photo at the same time to the designated social network and/or other digital devices, so as to simplify the photo sharing procedure.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram illustrating an instant photo sharing method according to a first embodiment of the present invention.

FIG. 2 is a block diagram illustrating the instant photo sharing arrangement according to the above first embodiment of the present invention.

FIG. 3 illustrates an interface of the instant photo sharing arrangement on the digital device according to the above first embodiment of the present invention.

FIG. 4 is a flow diagram illustrating an instant photo sharing method according to a second embodiment of the present invention.

FIG. 5 is a block diagram illustrating the instant photo sharing arrangement according to the above second embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

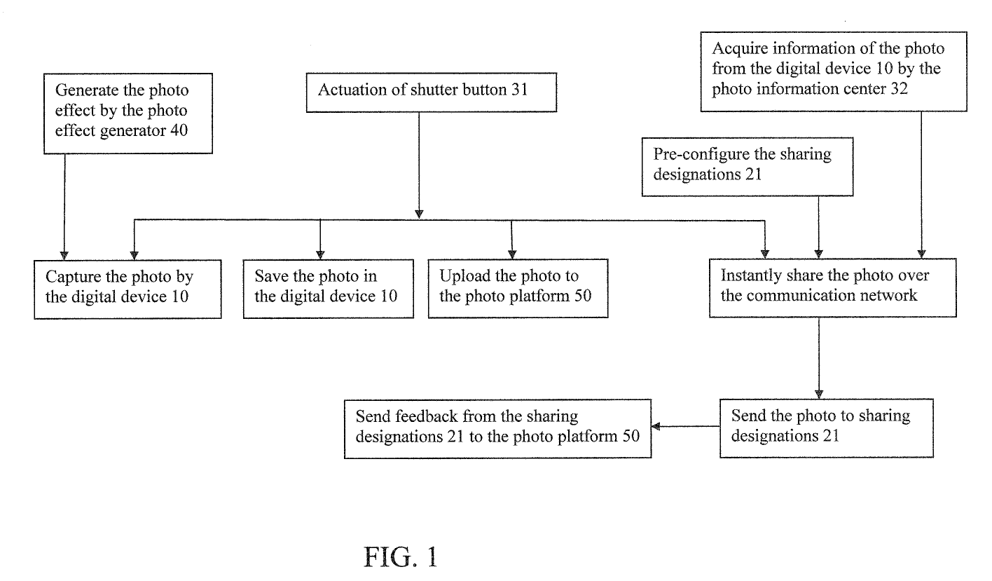

Referring to FIG. 1 of the drawings, an instant photo sharing method according to a first embodiment of the present invention is illustrated, wherein the method comprises the following steps.

(1) Capture a photo by a digital device 10.

(2) Instantly share the photo over a communication network at the same time when the photo is captured by the digital device 10.

According to the preferred embodiment, the digital device 10 can be an electronic device such as mobile phone, computer, tablet, or digital camera, wherein the digital device 10 comprises a camera module 11 having a lens module and a camera function to capture the photo, especially for the snapshot photo. In particular, the digital device 10 is adapted to link to the communication network, such as mobile communication network, “WiFi”, or the like.

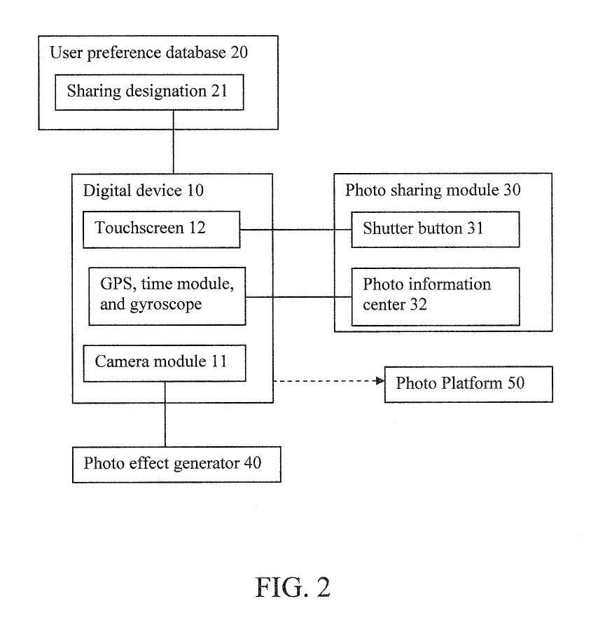

Accordingly, the instant photo sharing arrangement of the present invention is configured as a photo capturing and sharing software to be installed into the digital device 10. As shown in FIG. 2, the instant photo sharing arrangement comprises a user preference database 20 and a photo sharing module 30.

The user preference database 20 contains one or more sharing designations 21 pre-configured by the user of the camera module 11, wherein the sharing designation 21 can be a social network and/or other digital devices where the user wants to share the photo thereto.

Accordingly, before the step (1), the instant photo sharing method further comprises a configuration step of pre-configuring one or more of the sharing designations 21 in the digital device 10 such that the photo is captured and instantly shared at the same time to the sharing designation 21. For example, the user is able to set another digital device of a friend as the sharing designation in the user preference database 20, such that when the user takes the photo by the camera module 11 of the digital device 10, the photo will be automatically and instantly share to the friend's digital device. Likewise, the user is able to set the friend's digital device and “Facebook” as two sharing designations 21 in the user preference database 20, such that when the user takes the photo by the camera module 11 of the digital device 10, the photo will be automatically and instantly share to the friend's digital device and “Facebook” at the same time.

The photo sharing module 30, which is linked to the user preference database 20, comprises a shutter button 31 for operating the camera module 11 to capture the photo, wherein when the photo is taken by the camera module 11 via an actuation of the shutter button 31, the photo is captured and instantly shared at the same time to the sharing designation 21 over the communication network. It is worth mentioning that when the shutter button 31 is actuated, the photo will be captured and instantly shared, and will also be saved in the digital device 10.

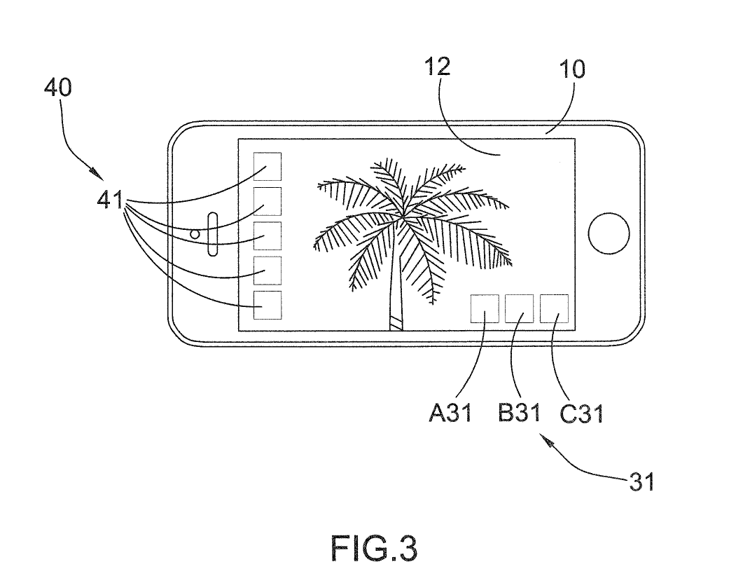

FIG. 3 illustrates the instant photo sharing arrangement of the present invention installed into the mobile phone as the digital device 10 which comprises a touchscreen 12 as an input. The shutter button 31 is displayed on the touchscreen 12 of the digital device 10, such that when the shutter button 31 is touched or pressed, the camera module 11 of the digital device 10 will capture the photo. At the same time, the photo will be instantly share to the sharing designation 21. In other words, the shutter button 31 for capturing the photo is the same as a sharing button for instantly sharing the photo, such that when the shutter button 31 is actuated, the photo is captured and shared at the same time. In other words, the user will only touch or press the shutter button 31 to capture and share the photo at the same time. Therefore, the user of the digital device 10 is able to capture and instantly share the photo at the same time to the designated social network and/or other digital devices, so as to simplify the photo sharing procedure.

When two or more sharing designations 21 are set in the user preference database 20, the user is able to capture and instantly share the photo to one or more sharing designations 21. Accordingly, the shutter button 31 comprises two or more shutter icons A31, B31, C31 corresponding to different sharing designations 21 pre-configured in the user preference database 20 respectively, such that when one of the shutter icons A31, B31, C31 is actuated, the photo is captured and instantly shared to the corresponding sharing designation 21. For example, first, second, and third sharing designations 21 are pre-configured in the user preference database 20, wherein three different shutter icons A31, B31, C31 are displayed on the touchscreen 12 of the digital device 10 corresponding to the first, second, and third sharing designations 21 respectively. Therefore, when the first shutter icon A31 is touched or pressed, the photo will be captured and instantly shared to the first sharing designation 21.

According to the preferred embodiment, the photo sharing module 30 further comprises a photo information center 32 acquiring information of the photo from the digital device 10. Accordingly, the information of the photo contains location, time and capturing orientation of the photo.

In the step (1) at the time when the photo is captured, the information of the photo will be obtained, such that once the photo is captured and instantly shared, the information of the photo will be gathered for instantly sharing. In particular, the photo sharing module 30 will obtain the capturing location of the photo from the GPS of the digital device 10. The photo sharing module 30 will obtain the capturing time of the photo from the time module of the digital device 10. The photo sharing module 30 will obtain the capturing orientation of the photo from the gyroscope data of the digital device 10. It is worth mentioning that the capturing orientation of the photo is the orientation of camera module 11 to capture the photo, such as facing “West”. The gyroscope data may contain “roll”, “pitch”, and “yaw”. Therefore, after the photo is shared, the information of the photo will be shown in the sharing designation 21, such that friends can view the photo and information thereof. It is worth mentioning that the user is able to sort the photos by the information of the photo, such as locations and/or timeline.

According to the preferred embodiment, the user is able to create a photo effect when capturing the photo. Accordingly, the instant photo sharing arrangement further comprises a photo effect generator 40 linked to the camera module 11 for generating the photo effect before the photo is captured. The photo effect generator 40 provides a plurality of photo effect settings 41, such as “Classic”, “Lomo”, “Vintage”, “Black and White”, and/or “Color Splash”, such that the user is able to select one of the photo effect settings to capture the photo. Preferably, the photo effect settings 41 are displayed on the touchscreen 12 of the digital device 10 for the user to select, as shown in FIG. 3.

In particular, “Mosaic” effect is provided as one of the photo effect settings 41, wherein the user is able to create the photo-mosaic on a particular area of the photo to be created. For example, the user is able to create the photo-mosaic on person's face on the photo for protecting personal privacy. Preferably, the photo-mosaic will be automatically created by the photo effect generator 40 via the facial detection of the camera module 11.

The instant photo sharing arrangement further comprises a photo platform 50 communicatively linked to the digital device 10 over the communication network, wherein the photo will also be uploaded to the photo platform 50 when the photo is captured and instantly shared. Accordingly, the user must be registered as a member of the photo platform 50 in order to upload the photo thereto. The photo platform 50 can serve as “cloud” storage to store the photo. In addition, the photo platform 50 can also serve as a social network to link the user with others. After the photo is shared to the sharing designation 21, the photo platform 50 will receive feedback from the sharing designation 21. For example, when the friend likes the photo, the friend can send the feedback to the user through the photo platform 50, wherein the photo platform 50 will collect all feedbacks from different sharing designations 21. Likewise, the feedback can be a request to the user. For example, when the friend may request the user to capture the photo any different capturing orientations, the photo platform 50 will notify the user to capture the photo at the requested capturing orientation and instantly share the photo to the designated friend. There is a teaching way to teach the user as a beginner photographer to capture the photo at a corrected capturing orientation by instantly sharing the photo to the skilled photographer. Likewise, the instant photo sharing arrangement of the present invention can be considered as traffic indicator to instantly show the traffic condition by instantly sharing the traffic photo to the sharing designations 21.

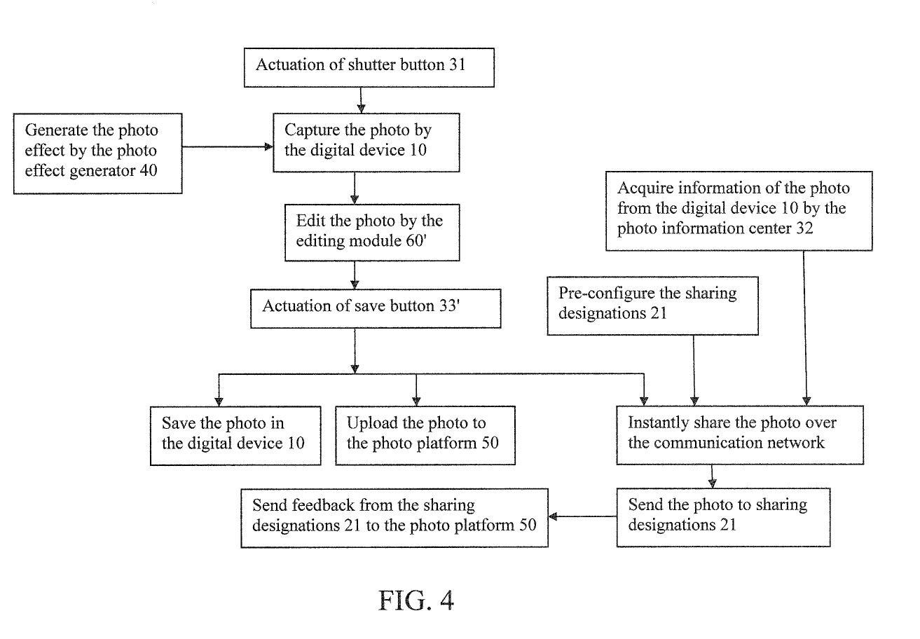

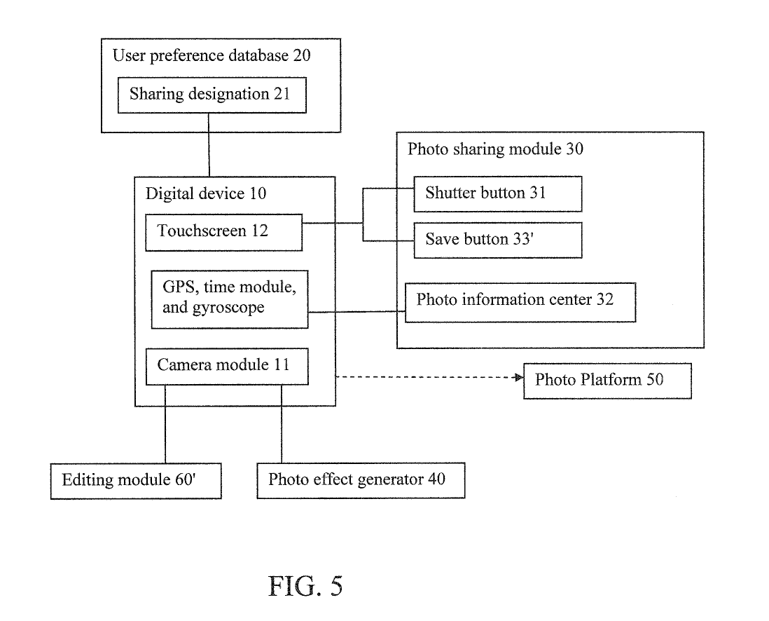

As shown in FIGS. 4 and 5, an instant photo sharing arrangement and method of the second embodiment illustrates a modification of the first embodiment to include an editing feature in the first embodiment. Accordingly, many users would like to edit the photo before sharing. The instant photo sharing method according to the second embodiment is modified to contain the following steps.

(1′) Capture and edit the photo by the digital device 10. Accordingly, the photo effect generator 40 is linked to the camera module 11 for generating the photo effect before the photo is captured.

(2′) Save the photo in the digital device 10.

(3′) Instantly share the photo over a communication network at the same time when the photo is saved in the digital device 10. Therefore, the user of the digital device is able to capture, edit, and instantly share the photo at the same time to the designated social network and/or other digital devices, so as to simplify the photo sharing procedure. It is worth mentioning that the information of the photo, including location, time and capturing orientation, is automatically collected by the photo information center 32 and is instantly shared over the communication network at the same time when the photo is shared in the step (3′).

In the step (1′), the photo sharing module 30, which is linked to the user preference database 20, comprises a shutter button 31 for operating the camera module 11 to capture the photo. After the photo is captured, the user is able to edit the photo via an editing module 60′ of the instant photo sharing arrangement. Accordingly, the editing module 60′ provides different editing tools to fix the photo, crop, resize, and rotate the photo, fix the exposure and color of the photo, to add text and frame on the photo, and/or touch-up the photo.

The photo sharing module 30 further comprises a save button 32′ for operating the digital device 10 to save the photo in the digital device 10. Once the photo is edited, the edited photo is saved in the digital device 10 via the actuation of the save button 32′. When the photo is saved in the digital device 10 via the actuation of the save button 32′, the photo is saved and instantly shared at the same time to the sharing designation 21 over the communication network. In other words, the save button 32′ for saving the photo in the digital device 10 is the same as the sharing button for instantly sharing the photo.

Preferably, the save button 33′ can be displayed on the touchscreen 12 of the digital device 10, such that when the save button 33′ is touched or pressed, the digital device 10 will save the photo. At the same time, the photo will be instantly share to the sharing designation 21. Similar to the shutter button 31 of the first embodiment, the save button 33′ comprises two or more save icons corresponding to different sharing designations 21 pre-configured in the user preference database 20 respectively, such that when one of the save icons is actuated, the photo is saved and instantly shared to the corresponding sharing designation 21. In other words, no matter which save icon is actuated by the user, the photo will be saved in the digital device. However, the photo will be instantly shared to the designated sharing designation 21.

Accordingly, the photo platform 50 is communicatively linked to the digital device 10 over the communication network, wherein the photo will also be uploaded to the photo platform 50 when the photo is saved and instantly shared.

Therefore, the difference between the first and second embodiments is that the photo is instantly when the photo is captured according to the first embodiment while the photo is instantly when the photo is saved according to the second embodiment.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An instant photo sharing method, comprising the steps of:
(a) capturing a photo by a digital device; and
(b) instantly sharing said photo over a communication network at the same time when said photo is captured by said digital device.

2. The instant photo sharing method as recited in claim 1 wherein, in the step (b), a shutter button for capturing said photo is the same as a sharing button for instantly sharing said photo, such that when said shutter button is actuated, said photo is captured and shared at the same time.

3. The instant photo sharing method, as recited in claim 1, wherein the step (b) further comprises a step of automatically sharing information of said photo, including location, time and capturing orientation, over said communication network at the same time when said photo is shared.

4. The instant photo sharing method, as recited in claim 2, wherein the step (b) further comprises a step of automatically sharing information of said photo, including location, time and capturing orientation, over said communication network at the same time when said photo is shared.

5. The instant photo sharing method, as recited in claim 3, wherein said location information of said photo is provided by a GPS of said digital device, said time information of said photo is provided by a time module of said digital device, and said capturing orientation of said photo is provided by gyroscope data of said digital device.

6. The instant photo sharing method, as recited in claim 4, wherein said location information of said photo is provided by a GPS of said digital device, said time information of said photo is provided by a time module of said digital device, and said capturing orientation of said photo is provided by gyroscope data of said digital device.

7. The instant photo sharing method, as recited in claim 1, before the step (a), further comprising a configuration step of pre-configuring at least one sharing designation in said digital device such that said photo is captured and instantly shared at the same time to said sharing designation.

8. The instant photo sharing method, as recited in claim 4, before the step (a), further comprising a configuration step of pre-configuring at least one sharing designation in said digital device such that said photo is captured and instantly shared at the same time to said sharing designation.

9. The instant photo sharing method, as recited in claim 1, wherein the step (a) further comprises a step of generating a photo effect before said photo is captured.

10. The instant photo sharing method, as recited in claim 8, wherein the step (a) further comprises a step of generating a photo effect before said photo is captured.

11. An instant photo sharing arrangement for a camera module, comprising:
a user preference database containing one or more sharing designations pre-configured by a user of said camera module; and
a photo sharing module, which is linked to said user preference database, comprising a shutter button for operating said camera module to capture a photo, wherein when said photo is taken by said camera module via an actuation of said shutter button, said photo is captured and instantly shared at the same time to said sharing designation over a communication network.

12. The instant photo sharing arrangement, as recited in claim 11, wherein said photo sharing module further comprises a photo information center acquiring information of said photo, including location, time and capturing orientation, from a GPS, time module, and gyroscope data of said camera module.

13. The instant photo sharing arrangement, as recited in claim 11, further comprising a photo effect generator linked to said camera module for generating a photo effect before said photo is captured.

14. The instant photo sharing arrangement, as recited in claim 12, further comprising a photo effect generator linked to said camera module for generating a photo effect before said photo is captured.

15. The instant photo sharing arrangement, as recited in claim 11, wherein said shutter button comprises two or more shutter icons corresponding to different sharing designations pre-configured in said user preference database respectively, such that when one of said shutter icons is actuated, said photo is captured and instantly shared to said corresponding sharing designation.

16. The instant photo sharing arrangement, as recited in claim 14, wherein said shutter button comprises two or more shutter icons corresponding to different sharing designations pre-configured in said user preference database respectively, such that when one of said shutter icons is actuated, said photo is captured and instantly shared to said corresponding sharing designation.

17. An instant photo sharing method, comprising the steps of:
(a) capturing and editing a photo by a digital device;
(b) saving said photo in said digital device; and
(c) instantly sharing said photo over a communication network at the same time when said photo is saved in said digit device.

18. The instant photo sharing method as recited in claim 17 wherein, in the step (c), a save button for saving said photo in said digital device is the same as a sharing button for instantly sharing said photo, such that when said save button is actuated, said photo is saved and shared at the same time.

19. The instant photo sharing method, as recited in claim 18, wherein the step (c) further comprises a step of automatically sharing information of said photo, including location, time and capturing orientation, over said communication network at the same time when said photo is shared.

20. The instant photo sharing method, as recited in claim 19, before the step (a), further comprising a configuration step of pre-configuring at least one sharing designation in said digital device such that said photo is captured and instantly shared at the same time to said sharing designation.
